(19) United States
(12) Patent Application Publication
(10) Pub. No.: US 2025/0106026 A1
(43) Pub. Date: Mar. 27, 2025

(54) Precomputation-Based Message Authentication

(71) Applicants: Singapore University of Technology and Design, Singapore (SG); Illinois at Singapore Pte. Ltd., Singapore (SG)

(72) Inventors: Ertem ESINER, Singapore (SG); Utku TEFEK, Singapore (SG); Binbin CHEN, Singapore (SG); Daisuke MASHIMA, Singapore (SG); Yih-Chun HU, Singapore (SG)

(21) Appl. No.: 18/279,042

(22) PCT Filed: Feb. 24, 2022
(86) PCT No.: PCT/SG2022/050089

§ 371 Date: Aug. 25, 2023

(30) Foreign Application Priority Data
Feb. 26, 2021 (SG) 10202102026P

(51) Int. Cl. H04L 9/32

(52) U.S. Cl. CPC H04L 9/3218

(57) ABSTRACT

Apparatuses and methods for precomputation based message authentication by generating a plurality of predicted messages; pre-computing a data structure for generation of cryptographic evidence for future messages; determining cryptographic evidence for a true message and transmitting the true message and the cryptographic evidence to destination apparatuses.

### TECHNICAL FIELD

The present disclosure relates generally to apparatuses and methods for message authentication. In particular, the disclosure relates to message authentication for industrial control systems, smart grids, financial systems and others.

### BACKGROUND

Attacks against industrial control systems (ICS) often exploit the insufficiency of authentication mechanisms in ICSs. Verifying whether the received messages are intact and issued by legitimate sources can address false data injection by illegitimate devices. Further, such ICSs are subject to other constraints such as the need for minimal delay (e.g., automated control commands for protection in smart grids need to be delivered within 2 milliseconds) and communication overheads in a variety of ICS communication infrastructure including multicast communication. The various apparatuses of ICSs may also have limited computational resources such as processing power and memory imposing further constraints on the authentication methodologies.

While digital signatures are widely used for multicast/broadcast authentication, they may not be suitable for resource-constrained devices or delay stringent applications. Some authentication schemes offload some computations of digital signatures to a phase before the message is given. Online/offline signatures, either based on one-time signature schemes or based on chameleon commitments can transform any digital signature scheme to one with such offloading features. Although the online signing in online/offline converted signature schemes can be fast, these schemes still fall short of meeting stringent latency requirements due to their offline phase requiring a large volume of metadata to be stored by the source. Other authentication schemes that amortize a signature over several packets may also not be satisfactory in avoiding large computation and communication overheads, and may not be robust against packet losses, or may lack immediate verification.

In conventional point-to-point communication settings, the straightforward method of appending a message authentication code (MAC) to each packet using a shared secret key allows the destination to perform this verification. While computationally inexpensive, such symmetric cryptography approaches with a group key are not secure for broadcast and multicast communication settings, because any destination possessing the shared secret key can impersonate the source, and inject forged packets. To address such attacks, pairwise symmetric keys can be used. However, pairwise key-based authentication is computationally intensive. Other downsides of pairwise keys include the complicated key distribution and storage overheads required to administer the authentication infrastructure.

Increasing demand for low-latency, high-rate messaging in ICSs deems digital signatures and related cryptography based schemes infeasible for message authentication due to their high overhead. For example, according to the IEEE Power and Energy Society guidelines, automated control for protection in a field substation of a smart grid, e.g., control on circuit breakers when overcurrent occurs on a transmission line, requires response time to be as low as 2 ms, including all the network related and processing delays. Because of this tight requirement, IEC 61850—an increasingly adopted standard for substation automation utilizes link-layer multicast for sharing such emergency event information with hundreds of devices. Another challenge is that the packets containing measurements on power grid status are sent at a very high rate (i.e., 4,000 or 12,800 packets per second according to the IEC 61850 SV standard). Therefore, even if some of the computations are offloaded to the pre-message phase, the pre-computation overhead should be very small to allow high-rate message authentication.

It would be desirable to overcome or alleviate at least one of the above-described problems, or at least to provide useful alternative apparatuses or methods for message authentication.

### SUMMARY

Methods and apparatuses described herein enable authentication of messages using lightweight message authentication schemes referred to as CMA (Caching-based Message Authentication) or CMMA (Caching-based Multicast Message Authentication). These methods may be referred to as the Precomputation-based Message Authentication scheme (Pre-MA) and Precomputation-based Multicast Message Authentication (Pre-MMA), respectively. The authentication methods perform pre-computation and caching operations on a source apparatus to enable authentication of messages by destination apparatuses.

In one aspect, the method is embodied in an apparatus for providing authentication information. The apparatus comprises: one or more processors; a memory storing instructions that when executed by the one or more processors, cause the apparatus to: generate a plurality of predicted messages based on a known structure of the message and/or based on a plurality of past messages having a same structure as the message; pre-compute, based on at least one of the predicted messages, a data structure for generation of cryptographic evidence for future messages; receive a true message; determine a cryptographic proof for the true message based on the pre-computed data structure; transmit the true message and the cryptographic proof to at least one message destination apparatus.

The cryptographic proof may be determined by: comparing content of the true message to the predicted messages; selecting one of said predicted messages based on its similarity or identity to the true message; and retrieving the cryptographic proof from the pre-computed data structure using the selected one of the predicted messages.

The pre-computed data structure may comprise an authenticated binary tree based on the predicted messages. The authenticated binary tree may be constructed based on: the predicted messages and probabilities of the respective predicted messages. Each leaf node of the binary tree may contain a hash of the concatenation of a predicted message and a nonce.

The source apparatus may determine a root value for the authenticated binary tree by iterative pairwise hashing of values of nodes of the binary tree; and shares the root value with the at least one message destination.

The source apparatus may determine the cryptographic proof by: determining a leaf node in the binary tree that corresponds to the true message; and traversing the binary tree to retrieve hashes of siblings of nodes on a path between the corresponding leaf node and the root; wherein the cryptographic proof comprises a combination of the nonce value of the corresponding leaf node, and the hashes of all sibling nodes on the path.

The source apparatus can initialise a series of hash chain values, the series of hash chain values comprising a final hash chain value (C₀), wherein each hash chain value corresponds to a specific transmission interval; transmits the final hash chain value to at least one message destination apparatus.

The source apparatus can recalculate the data structure for generation of cryptographic evidence for each specific transmission interval; the cryptographic proof is determined based on the recalculated data structure and the hash chain value corresponding to the specific transmission interval.

Also disclosed herein is an apparatus for receiving information and authenticating received information, the apparatus comprising: one or more processors; a memory storing instructions that when executed by the one or more processors, cause the apparatus to: receive a first root value for authenticating future messages; verify the received root value; receive a message and a cryptographic proof generated by a source apparatus; verify the received message by calculating a second root value based on the cryptographic proof and comparing the second root value with the first root value.

Also disclosed herein is an apparatus for receiving information and authenticating received information, that receive a final hash chain value from a message source apparatus; verify the received final hash chain value using a digital signature or a previously received hash chain value; receive a message, a cryptographic proof and a hash chain value from a source apparatus of claim; verify the current hash chain value based on the previously received final hash chain value; on verifying the current hash chain value, verifying the received message based on the cryptographic proof and the current hash chain value.

Also described is a method for providing authentication information for a message, comprising, at a message source: prior to receiving or generating the message: generating a plurality of predicted messages based on a known structure of the message and/or based on a plurality of past messages having a same structure as the message; and pre-computing, based on at least one of the predicted messages, a data structure for generation of cryptographic evidence for future messages; and on receiving or generating the message (true message), determining a cryptographic proof for the true message based on the pre-computed data structure.

Some embodiments relate to non-transitory computer-readable storage having stored thereon machine-readable instructions for causing at least one processor to carry out a method as described above.

### BRIEF DESCRIPTION OF THE DRAWINGS

Some embodiments of apparatuses and methods for message authentication in accordance with the present disclosure are described by way of non-limiting examples with reference to the accompanying figures in which:

FIG. 1 is a message timing diagram illustrating the processing loads and transmission delays under baseline authentication schemes and authentication schemes according to the disclosure;

FIG. 2 is a data structure for the generation of cryptographic evidence for future messages;

FIG. 3 is a high-level flowchart of various steps of message authentication;

FIG. 4 is a schematic diagram illustrating Caching-based Multicast Message Authentication (CMMA);

FIG. 5 is a graph of precomputation time as a function of the number of subscribers for the disclosed methods and benchmark methods;

FIG. 6 is a graph of precomputation time as a function of the number of predicted messages for the disclosed methods and benchmark methods;

FIG. 7 is a graph of verification time as a function of the number of predicted messages for the disclosed methods and benchmark methods.

FIG. 8 is a graph of verification time as a function of the number of predicted messages for the disclosed methods under various probability distributions of prioritised messages;

FIG. 9 is a block diagram of apparatuses that implement the disclosed methods;

FIG. 10 is a flowchart of a method performed by a message source apparatus; and

FIG. 11 is a flowchart of a method performed by a message destination apparatus.

### DETAILED DESCRIPTION

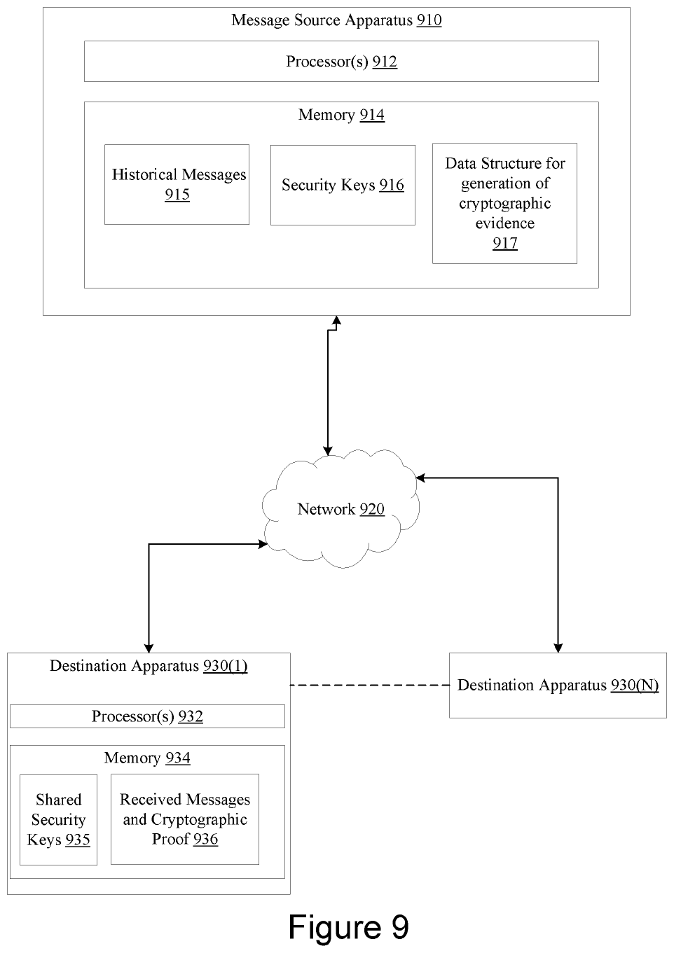

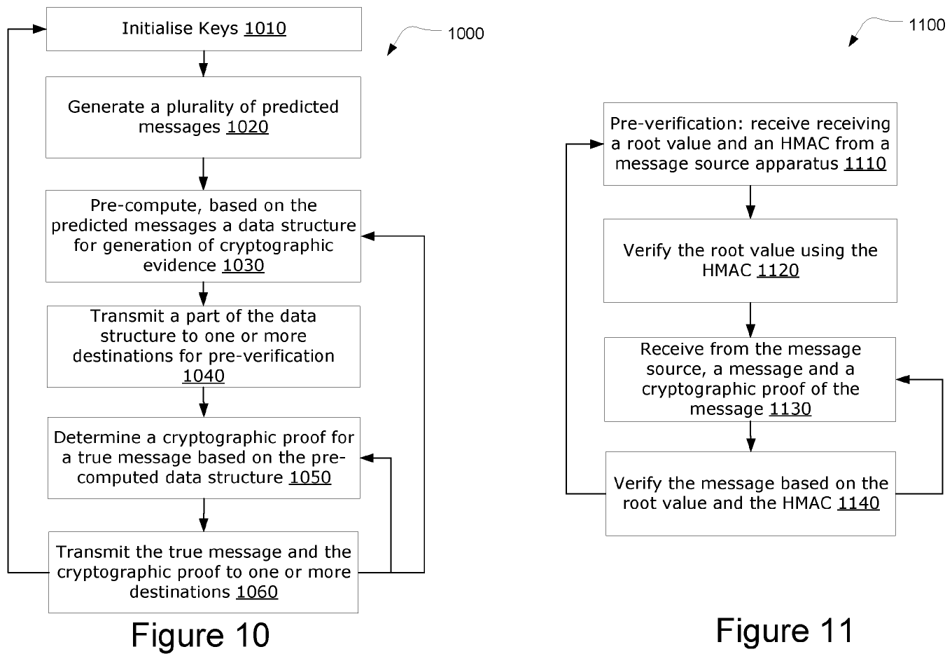

Industrial control systems comprise a large number of apparatuses distributed over a wide area. Several apparatuses of an ICS communicate with each other or with components outside of the ICS to perform their respective control operations using messages transmitted over one or more communication networks. The methods and apparatuses described below enable authentication of messages using lightweight message authentication schemes referred to as CMA and CMMA or their alternative names, being interchangeably referred to as Pre-MA and Pre-MMA, respectively. These methods perform the pre-computation and caching operations on a source apparatus to enable authentication of messages by destination apparatuses. An exemplary part of an ICS illustrating a message source apparatus 910 in communication with one or more destination apparatus 930(1) . . . 930(N) is illustrated in FIG. 9. The present authentication methods are executed by the processor(s) 912 of the source apparatus 910 to perform precomputation and/or caching and generate messages and cryptographic proof associated with the messages. A method 1000 for precomputation and generation of cryptographic proof executable by the source apparatus 910 is exemplified in FIG. 10. The destination apparatuses 930(1) . . . 930(N) receive messages and cryptographic proof from the source apparatus 910 and execute one or more methods, such as method 1100 of FIG. 11, to verify or authenticate the received messages.

ICS messages have certain domain-related features, such as predictable and structured message content. The domain related features are exploited by some embodiments to facilitate efficient message authentication. ICS messages are often semantically fragmented into predefined fields. The fields include IP addresses, some constants (e.g., number of entries, expiry period), a command or measurement(s) (e.g., voltage, frequency values and alerts), and a timestamp. The disclosed authentication methods (also sometimes referred to as signature schemes) exploit the structure of such messages to enable pre-computation for a verifier-efficient scheme such as RSA SecureID.

The predictability of the ICS messages is also exploited by some of the disclosed authentication methods. Some message fields contain predetermined values such as IP addresses, sequence numbers and expiry period that are known to the source long before the message has to be sent. Other fields may contain measurements such as voltage, frequency readings that always fluctuate around certain values, or contain a limited number of binary flags indicating urgent commands/alerts. The measurement values can be largely predictable due to their almost constant base value, while the urgent binary values can only yield a limited number of possible outcomes. The disclosure describes the feasibility of message prediction with reference to IEC 61850 GOOSE (Generic Object Oriented Substation Event) protocol. The predictability of ICS messages using alternative protocols may also be exploited by the embodiments based on the principles applicable to the GOOSE protocol.

The disclosure contrasts the approaches of the present methods with baseline approaches, in performing precomputation for message authentication in ICSs. The baseline approaches incur significant precomputation and/or communication overhead to minimize the computations after the message is generated or made available (post-message).

A proof mechanism is incorporated into the methods. The proof mechanism uses a data structure for the generation of cryptographic proof. The data structure may include authenticated trees e.g., Huffman Hash Tree (HHT) or Merkle Hash Tree (MHT) to reduce or avoid the precomputation and communication overhead of the baseline designs or provide a more computationally efficient and/or scalable alternative. The authentication schemes of some embodiments incorporate symmetric keys for encryption and hence do not suffer the drawbacks of asymmetric cryptography. CMA embodiments incorporate MACs (Message Authentication Codes) and are preferable when the number of destination apparatuses is small. CMMA embodiments incorporate delayed key disclosure, thus its overhead does not depend on the number of destinations, however, it requires loose time synchronization. Despite the delayed disclosure of keys, CMMA does not suffer from the disclosure delay of baseline schemes. CMMA is suitable for certain ICS protocols such as the increasingly adopted IEC 61850 in smart grid systems, where the messages consist of system states and parameters which are largely static or predictable. These methods are also inherently more suited to larger numbers of destination apparatuses.

With minimal precomputation and communication overhead, CMA/CMMA embodiments eliminate or substantially reduce cryptographic operations for the message source after the message is generated/determined/received, and all or a substantial part of expensive cryptographic operations for the destination apparatuses. Some embodiments consider the urgency profile (or likelihood, or probability distribution) of a set of future messages for even faster verification of the most time-critical (or likely) messages.

In conventional point-to-point communication settings, appending a message authentication code (MAC) to each packet using a shared secret key allows the destination to perform this verification. While computationally inexpensive, such symmetric cryptography approaches with a group key are not secure for broadcast and multicast communication settings, because any destination in possession of the shared secret key can impersonate the source and inject forged packets. To prevent this attack, pairwise symmetric keys may be deployed in conventional systems. With pairwise symmetric keys, however, the source needs to generate a separate MAC for each destination, increasing the computational load linearly as the number of destinations increases. Conventional digital signatures require expensive computations, such as modular exponentiation (RSA), elliptic curve scalar multiplication (ECDSA), and cryptographic pairing, which introduces high overhead for signing and verification, especially on resource-constrained devices (e.g., legacy ICS devices). Other downsides of pairwise symmetric keys are the complicated key distribution and storage overhead. The authentication schemes of some embodiments introduce asymmetry between the source and destinations to address the problems associated with purely symmetric authentication schemes.

This disclosure describes several baseline caching approaches that pre-compute and store data structures for generating cryptographic evidence. Cryptographic evidence comprises a piece of information to verify the source and integrity of the message-for potential future messages. The baseline designs incur significant precomputation and communication overhead to minimize the computations after the message is generated or determined (post-message).

### Design Goals and Threat Model

The forgery or manipulation of messages in ICS would have serious consequences. Among the wide range of industrial control systems, because of the time-critical nature and significance of the consequences of an attack. The disclosed embodiments may be deployed in modernized power grid systems.

### Smart Grid Cybersecurity Threats

In ICSs in general, ensuring message integrity and authenticity is critical for defending against threats including malicious command injection, false data injection and denial of service (DOS) attacks. For instance, verifying that the commands/messages have been initiated only by trusted devices and have not been altered by an unauthorized party can thwart malicious command injection and false data injection attacks. DOS attacks are much harder to prevent due to their various forms. Besides the types of DOS attacks taking advantage of protocol specifications (as discussed above), the message authentication mechanism can also be targeted by the DOS attacks. Methods described herein provide a verifier-efficient message authentication scheme for resilience against computational DoS attacks.

In power grid systems, as is the case with many other ICSs, timely communication among the devices is imperative. In the modernized power grid systems a publisher-subscriber communication protocol, is used among a predefined group of devices, e.g., intelligent electronic devices (IEDs) and programmable logic controllers (PLCs), for regular status updates and urgent control communication. The status updates are announced both regularly and in an on-demand manner whenever the status or measurement of the power grid device is updated, and messages for propagating events such as over current and automated protection control (e.g., opening circuit breakers) require very short latency (1-2 ms). Besides the end-to-end latency, throughput requirement also poses a challenge. For instance, IEC 61850 SV (Sampled Value) protocol has almost the identical message structure and communication model, but it is sent with a constant and much higher rate (e.g., 4,000 messages/sec).

Against this threat model, present methods provide a message authentication mechanism that incurs minimal overhead even for multicast traffic and is also verifier-efficient. Such a defence mechanism is to be deployed on ICS devices or Bump-in-the-wire (BITW) devices in front of them. Note that BITW devices are not addressable and thus not accessible to remote attackers in the present scope.

### Entropy of ICS Messages

At the high level, the advantage of reducing the latency in authenticating ICS messages is provided by precomputation and caching of the cryptographic evidence for potential future messages. Such a strategy is feasible when the timing and content of ICS messages are, to some extent, predictable. The entropy of ICS messages is described using IEC 61850 GOOSE as a concrete example. The embodiments may be deployed to operate with other ICS based communication protocols and the IEC 61850 GOOSE merely serves as a tangible example.

The section below reproduces an exemplary GOOSE Protocol Data Unit (PDU).
GOOSE
   APPID: 0x03e8 (1000)
   Length: 185
   Reserved 1: 0x0000 (0)
   Reserved 2: 0x0000 (0)
   goosePdu
      gocbRef: LIED11MEAS/LLNO$Measurement
      timeAllowedtoLive: 3000
      datSet: LIED11MEAS/LLNO$Measurement
      goID: LIED11MEAS/LLNOSMeasurement
      t: May 9, 2019 07:41:32.528999984 UTC
      stNum: 1
      sqNum: 0
      test: False
      confRev: 1
      ndsCom: False
      numDatSetEntries: 10
      allData: 10 items
GOOSE
   APPID: 0x03e8 (1000)
   Length: 185
   Reserved 1: 0x0000 (0)
   Reserved 2: 0x0000 (0)
   goosePdu
      gocbRef: LIED11MEAS/LLNOSMeasurement
      timeAllowedtoLive: 3000
      datSet: LIED11MEAS/LLNO$Measurement
      goID: LIED11MEAS/LLNOSMeasurement
      t: May 9, 2019 07:41:32.528999984 UTC
      stNum: 1
      sqNum: 0
      test: False
      confRev: 1
      ndsCom: False
      numDatSetEntries: 10
      allData: 10 items

As shown above, an exemplary GOOSE Protocol Data Unit (PDU) consists of a GOOSE control block reference (gocbRef), a twobyte long timeAllowedtoLive field specifying the lifetime of the message, an identifier of the dataset included (datSet), a GOOSE ID (goID), an 8-byte long timestamp (t), a status number (stNum), a sequence number (sqNum) which is incremented by one or rolled over to zero upon each packet transmission, a test bit test, configuration revision (confRev) and needs commissioning (ndsCom) flags, and the number of user-defined data entries (numDatSetEntries). The last portion of the exemplary GOOSE packet is the allData field, which stores device/alarm status and measurements. This portion is the user defined (allData) field the content of which is determined by the Substation Configuration Language (SCL) file.

The prediction of GOOSE PDU fields is trivial except for the timestamp t and user-defined allData field. An approximate timestamp value would be sufficient for messages to be accepted at their destination given that timeAllowedtoLive is typically greater than 100 ms, much larger than the targeted latency of 1-2 ms.

The data conveyed in allData field may consist of several binary values or a few multi-byte values to convey current, voltage, frequency readings depending on the type of dataset in the GOOSE message. Based on the observation from the SCL files of a smart grid testbed, there could be three types of messages: Control, Protection, and Measurement. Control data includes two boolean values indicating circuit breaker status and a quality value (generally “0000”) associated with each. Similarly, the Protection data includes a boolean field indicating a fault occurrence, the same quality value. The prediction of these binary values is viable given the limited space for possible outcomes.

Measurement data includes 10-12 measurements, each consisting of several bytes representing voltage, current, or frequency. Such measurements fluctuate within a certain range (e.g., around 49.9-50.1 Hz frequency) and typically do not change significantly over time. In addition, a prediction method can be used to narrow down the space further. Therefore, the set of possible measurements can be reduced to a much smaller set of potential messages to be prioritized. While predicting a large number of measurements is often non-trivial, Measurement packets may not be as time critical as Protection and Control packets. Thus, the disclosed methods can still be opportunistically applied to Measurement packets with lower priority.

The prediction of data conveyed in allData field can be improved by analyzing the past measurements using statistical methods. Expected GOOSE messages may be characterized by observing the normal operation. Various message prediction techniques may be incorporated in the disclosed embodiments. The advantages of the disclosed embodiments may be realised independently of the various prediction techniques. This disclosure operates with the priori that a message publisher or a message source apparatus can obtain a set of possible messages (and their relative delay tolerance profile or likelihood if applicable) prior to the establishment/determination of the actual message. Although precise message prediction is not required for realising the technical advantages of the disclosed embodiments, the overall efficiency may marginally improve with improved message prediction. Message prediction is also a very domain specific operation and messages in certain domains of ICSs may be inherently more predictable than other domains resulting in marginal variation in overall performance of the disclosed embodiments.

The source (message source apparatus) can prepare for all or a majority of possibilities (e.g., for possible state changes or no state change) within each timeAllowedtoLive period. Not all sets of prepared packets may end up being transmitted to the destination(s). For instance, even if the source prepares for state change before the timeAllowedtoLive expiry, no state change may occur, resulting in a higher rate of packet generation than the message arrival rate to the destination. Thus, the rate required to prepare packets in advance, i.e., R2, would be greater than the actual message arrival rate, R1.

### Comparative Baseline Approaches to Reduce Delay Overhead

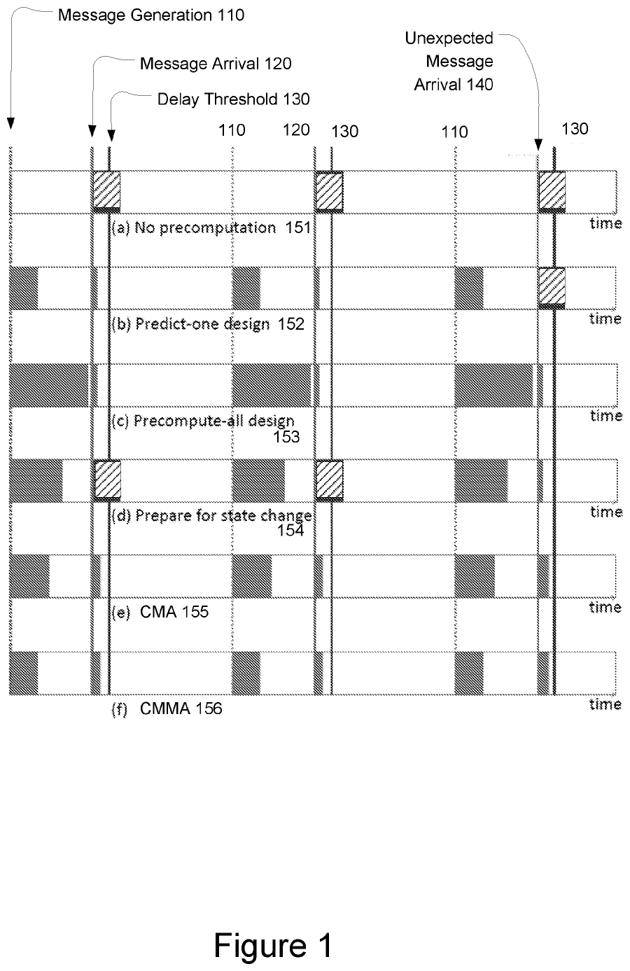

FIG. 1 is a message timing diagram illustrating the processing loads and transmission delays under prior art/baseline designs and designs according to the invention. The x-axis of FIG. 1 corresponds to time and various events over time or thresholds and they are identified using vertical lines. The y-axis of FIG. 1 corresponds to the performance of various baseline techniques and techniques according to the invention. The shaded regions of FIG. 1 correspond to the time required for computation performed by the message source apparatus for each method. A message generation point 110 corresponds to a point of time the message source apparatus initiates computation (if any) for the next expected message. The message arrival point 120 corresponds to the point of time an actual message is received by the message source apparatus. The delay threshold 130 corresponds to the maximum delay that may be acceptable to the ICS.

Table 1 below illustrates the performance and overhead of the various baseline designs and designs according to the invention.

TABLE 1
Complexity analysis.

| | # of secure | | # of secure | |
|---|---|---|---|---|
| | hashing in | # of secure hashing | hashing at the | communication |
| Design | post-message | at the publisher | subscriber | overhead |
| (a) No pre- | 2N | 2N × R₁ | 2R₁ | N × R₁ |
| computation | | | | |
| 151 | | | | |
| (b) Predict-one | ~0 | 2N × R₂ | 2R₁ | N × R₁ |
| 152 | | | | |
| Precompute-all | 0 | 2N × 2^{k} × R₂ | 2R₁ | N × R₁ |
| State change | ~2N | 2N × (R₁ + 2^{ku} × R₂) | 2R₁ | N × R₁ |
| CMA w/MHT | 0 | (2N + 2^{k+1} − 1) × R₂ | (k + 3) × R₁ | N × (k + 2) × R₁ |
| CMA w/HHT | 0 | (2N + 2^{k+1} − 1) × R₂ | (D + 3) × R₁ | N × (D + 2) × R₁ |
| CMMA w/MHT | 0 | (3 + 2k + 1) × R2 | (k + 5) × R₁ | (k + 3) × R₁ |
| CMMA w/HHT | 0 | (3 + 2k + 1) × R2 | (D + 5) × R₁ | (D + 3) × R₁ |

N: number of subscribers, k: number of unpredictable binary fields, ku: number of unpredictable binary fields in an urgent message (ku < k), R1: message arrival rate, R2: 1/timeAllowedtoLive, D: depth of the true message.

To meet the stringent latency constraints in various ICSs, a straightforward solution is to use lightweight cryptographic MAC without any need for message prediction (no pre-computation 151—(a) of FIG. 1).

Predict-one design 152 ((b) of FIG. 1): This design reduces the average processing delay by caching the cryptographic evidence for only a single prospective message (preferably, the message with the highest probability to be sent), before the actual message is given/received/determined. The second row of Table 1 shows the required number of secure hash operations post-message. (b) of FIG. 1 illustrates the processor loads and packet delays for a case where the first two predictions hold true; hence the delays are minimal.

However, the third prediction is wrong (corresponding to the arrival of an unexpected message at 140), and the evidence for the “surprise” message needs to be generated on-the-fly, and this will still incur a delay as large as the no-precomputation 151 setting. Predict-one design would only be suitable for systems that require low average communication delay but can tolerate higher delay occasionally for surprise messages.

### Precompute Data Structure for Generating Cryptographic Evidence to Reduce Delay

The message source apparatus 910 generate a data structure 917 for generation of cryptographic evidence before the actual message is given/arrives (pre-message computation) based on the predicted future messages or historical messages 915. The following designs provide precomputation designs that may be suitable based on various characteristics of the messages.

Precompute-all design 152 (timeline (c) of FIG. 1): If the source could cache the cryptographic evidence for all the possible prospective messages, it would avoid cryptographic operations in the post-message phase. As shown in FIG. 1 (c), this design is feasible if precomputing a MAC for each possible message and destination is within the computing capability of the source hardware. This design ensures a delay upper bound at the cost of increased computation load. However, the computation load grows exponentially with the number of unpredictable binary fields in a message.

Prepare for state change by precomputing only for the urgent messages 154 (timeline (d) of FIG. 1): In this baseline design, the source always prepares the cryptographic evidence only for urgent messages in the pre-message phase. Although the load for precomputing for the urgent messages still grows exponentially with the number of binary fields in an urgent message (˜N×2^{ku}×R₂), this is still lower than the precompute-all design, since such urgent messages report a smaller number of unpredictable binary fields, i.e., ku<k. Added to that is the computational load for generating the evidence for the actual message (˜N×R₁), after the message arrives. (d) of FIG. 1 illustrates the computational loads for a prepare for state of change 154 based authentication protocol.

The first two messages are periodic messages containing no state change. Since the source only prepared for a state change, it has to generate the cryptographic evidence for the actual message after its arrival, incurring a delay equivalent to that of the no precomputation setting 151. Only if an urgent message arrives as in the third one at stage 140, the delay is much smaller because the cryptographic evidence has already been precomputed.

Although the approaches above can be useful in certain settings, they rely on heavy precomputation at the source to reduce message authentication delay. First, the precomputation and communication load increases dramatically with the number of unpredictable binary fields. Second, they suffer from a major drawback of all symmetric-key based approaches, which is the linear increase in the computation load with the number of destinations.

The disclosed methods and apparatuses incorporate authenticated trees (CMA) or a delayed key disclosure (CMMA) which results in smaller loads and delays as illustrated in the timelines (e) and (f) respectively of FIG. 1.

### Binary Tree Model for CMA and CMMA

Advantageously, the disclosed embodiments reduce the computation and communication loads and improve scaling capability by computing a data structure 917 which may comprise authenticated trees. Instead of computing cryptographic evidence/proof separately for each message, the message source apparatus constructs a binary tree (authenticated binary tree) on the set of possible/prioritized messages and uses the root of the tree as an aggregate prediction/prioritization outcome. The root value in some embodiments may be obtained by iterative pairwise hashing operations. This aggregate prediction outcome (i.e. the root) is shared with the destination apparatus(es) in the pre-message phase. Thus, instead of sharing each possible/prioritized future message and the corresponding evidence separately, the source caches the binary tree and then shares (only) the root (and a proof to authenticate it), which serves as a public meta-data within the ICS network to authenticate the true message, provided that it is among the set of prediction outcomes/prioritized messages. The embodiments may use MACs and/or TESLA to authenticate the root.

After the actual message is available/generated/determined at the source apparatus, its proof is generated by collocating (memory read) values from the tree. The protocol or series of steps for generating the proof is outlined in FIGS. 3, 10 and 11.

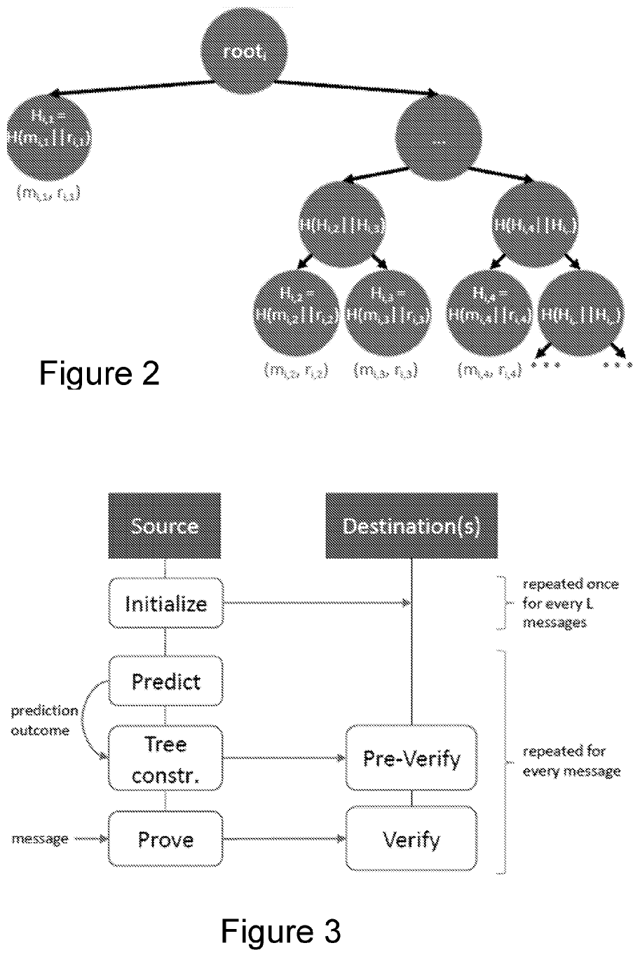

Since MHT (Merkle Hash Tree) is a special case of HHT (Huffman Hash Tree) where the frequencies or delay tolerance profiles of different messages are set to be equal, the disclosure describes the embodiments based on an authenticated HHT in FIG. 2. In an HHT implementation, the most likely messages (representing no state change) or the most delay stringent messages can be placed at higher levels (closer to the root) compared to those that are less likely and delay-tolerant. The HHT of FIG. 2 is an exemplary data structure for the generation of cryptographic evidence for future messages.

Analogous to the construction of minimum redundancy codes, a Huffman Hash Tree (HHT) is constructed on the possible messages, in a way that the expected depth of the leaf corresponding to the true message is minimized. To achieve this, the depth of the leaf corresponding to a certain message is set to the equivalent of the coding length of that message in Huffman Coding. FIG. 2 illustrates an exemplary data structure for the generation of cryptographic evidence in the form of a Merkle Hash Tree (MHT). As illustrated in FIG. 2, the data structure situates the messages (e.g., mᵢ, 1) with a higher priority closer to the root.

In an alternative HHT implementation, the most likely messages, such as the expected measurements, or the most delay-sensitive messages (e.g., certain alerts) can be placed closer to the root.

### CMA for Unicast ICS Communication

The following sections describe the disclosed methods using MACs to authenticate the messages within ICSs in the context of CMA for unicast ICS communications. FIG. 10 is a flow chart of a method 1000 performed by a processor(s) 912 of the message source apparatus 910 based on program code or instructions stored in memory 914. FIG. 11 is a flowchart of a method 1100 performed by a processor(s) 932 of the message destination apparatus 930. Method 1100 is performed at least partly in concert with/responsive to method 1000.

Initialize (A)→{K}: In step 1010, given the security parameter λ, the source apparatus initialises pairwise symmetric keys (security keys 916) K={sk₁, . . . , sk_{N}} associated with each destination apparatus 930. This procedure is performed during an initialization stage, and may be repeated for the transmission of every L messages.

Predict (History)→{Mᵢ, Pᵢ}: Step 1020 comprises prediction of messages based on historical messages generated at/made available to the message source apparatus 910. The input to the Predict step comprises the past messages 915 and system states that the prediction engine of the source apparatus uses to generate prediction outcomes. The predicted messages are based on a known structure such as a structure of ICS messages defined by a designated communication protocol. The outputs are the possible messages Mᵢ, and their respective normalized probabilities Pᵢ (or tolerable delays for an alternative design), for time interval i∈{1, . . . . L}. Whenever timeAllowedtoLive is about to expire, or a new prediction is available, the source device generates a new prediction outcome for that time interval. This prediction outcome consists of the set of possible messages Mᵢ={m_{i,1}, . . . , m_{i,2}_{^{k}}}, and the normalized probability of each message Pᵢ={p_{i,1} . . . , P_{i,2}_{^{k}}}, such that Σⱼ₌₁²^{^{k}}p_{i,j}=1. In some embodiments, the Pᵢ values may relate to a priority associated with each message Mᵢ.

Prioritize (preferences, system data)→{Mᵢ, Pᵢ}: In some embodiments, step 1020 may also comprise establishing a priority of the various predicted messages. The input to the Prioritize procedure includes operator's preference (e.g., in terms of message type or target devices to prioritize) and historical system data. The output consists of the set of possible messages Mᵢ={m_{i,1}, . . . , m_{i,2}^{k}}, and/or the normalized weight of each message Pᵢ={p_{i,1}, . . . , p_{i,2}^{k}} (based on probabilities or tolerable delays), such that Σⱼ₌₁²^{^{k}}p_{i,j}=1, for time interval i∈{1, . . . . L}. The output {Mᵢ, Pᵢ} is collectively referred to as the prioritization outcome. Whenever timeAllowedtoLive is about to expire, or a new input is available, the procedure may be repeated by the message source apparatus.

Tree construction (Mᵢ, Pᵢ, K, tsᵢ)−→{treeᵢ, rootᵢ, Sᵢ}: At step 1030, the message source apparatus pre-computes, based on the predicted messages a data structure 917 for generation of cryptographic evidence. The inputs to the tree construction step are Mᵢ, Pᵢ obtained from the output of the Prioritize step, the symmetric keys K shared with each destination, and the timestamp tsᵢ for freshness/keeping track of the age of the data structure. The outputs are the tree treeᵢ, its root value rootᵢ, and the set of HMACs Sᵢ={s_{i,1}, s_{i,2}, . . . , s_{i,N}} calculated from rootᵢ, using the corresponding shared key of each destination n∈{1, . . . , N}.

The constructed tree binds the prioritized messages to a root value rootᵢ. To prevent or reduce the likelihood of an adversary predicting the messages and hence calculating the same root value, each message is concatenated with a nonce in {r_{i,1}, . . . , r_{i,2}_{^{k}}} before calculating the leaf values. Then, the root is obtained by pairwise hashing of sibling nodes starting from the deepest nodes (iterative pairwise hashing). Finally, the root is timestamped and shared with the destination(s) apparatuses along with its HMAC, calculated separately for each destination using the pairwise symmetric keys established in the Initialize procedure of step 1010. In other words, s_{i,n}=HMAC(skₙ,tsᵢ,rootᵢ) is shared with destination n, ∀n∈{1, . . . , N}, where skₙ is the key shared between the source and destination n, and tsᵢ is the timestamp for the corresponding interval. The tree is only known to the source apparatus and it thus serves as the private meta-data.

At step 1040, the message source apparatus transmits a part of the data structure to one or more destinations for pre-verification. The part of the data structure may include a root value of the tree generated at step 1030. The root value may be encrypted using a symmetric key before transmission/sharing. When transmission occurs to a plurality of message destination apparatuses, the message to each destination apparatus is encrypted using a respective symmetric key established at step 1010.

Prove (m_{i,t}, treeᵢ)→{proofᵢ}: At step 1050, the source apparatus determines 910 a cryptographic proof for a true message based on the data structure pre-computed at step 1030. The true message may comprise an observation or sensor data received by the source apparatus or other relevant ICS message intended to be transmitted to one or more destinations. The inputs for the generation of the cryptographic proof are the true message m_{i,t}, and the treeᵢ constructed in the previous procedure, and the output proofᵢ is a collection of values from the tree between m_{i,t} and the root.

After the true message (say m_{i,t}) is known to the source, it navigates the data structure to obtain values of the cryptographic data structure corresponding to the true message by comparing the content of the true message to the predicted messages stored in the data structure 917. The source apparatus selects one of said predicted messages stored in the data structure 917 based on its similarity or identity to the true message and retrieves the cryptographic proof based on the selected message.

In embodiments in which the data structure 917 is an authenticated binary tree, the sources apparatus identifies a leaf node in the binary tree that corresponds to the true message by traversing through the data structure 917. To generate the cryptographic proof proofᵢ, the source apparatus retrieves hashes of siblings of nodes on a path between the corresponding leaf node and the root value.

The source apparatus sends m_{i,t} and the corresponding values of the cryptographic data structure (HHT or MHT) as proof at step 1060 to allow the destination(s) to verify the authenticity of the true message by calculating the root value.

For example, if m_{i,t}=m_{i,2} in FIG. 2, the proof contains {r_{i,2}, H_{i,1}, H_{i,3}, H(H_{i,4}∥H_{i,.})}. No hashing operations are performed at the source in the post message phase. Step 1050 may be repeated after step 1060 as new true messages are made available to the message source apparatus. After a pre-defined period, step 1010 is performed after step 1060 to reinitialise the keys and again pre-compute the data structure for generation of cryptographic proof to refresh the entire authentication scheme and further improve authentication robustness. Recomputing the data structure by execution of step 1030 advantageously allows the data structure to be refreshed for changing predictions and thus generate a data structure that more closely models the state of the ICS over time.

The various steps of method 1100 of FIG. 11 are performed by the processor(s) 932 message destination apparatus 930 based on instructions or program code stored in memory 934 to verify messages received from the message source apparatus.

Pre-Verify (skₙ, s_{i,n}, rootᵢ)−→{accept, reject}: At step 1110, for destination n, the root rootᵢ and its HMAC s_{i,n} is received by the destination apparatus following the Tree Construction step 1030. At step 1120, the destination apparatus verifies rootᵢ using the shared key skₙ 935 received earlier in response to the initialize procedure 1010. If accepted, root is stored for a timeAllowedtoLive period. Note that this pre-verification is done before the actual message is received by the destination device.

At step 1130, the destination apparatus receives from the message source, a message and a cryptographic proof 936 of the message in response to step 960 performed by the source apparatus.

Verify (m′_{i,t}, proofᵢ, rootᵢ)→{accept, reject}: At step 1140, the destination apparatus verifies the received message by executing a verify procedure. The inputs to the verify procedure are the message m′_{i,t} to be verified, its proof proofᵢ, sent by the source following its Prove procedure (step 1050) and the stored root value rootᵢ corresponding to the ith interval. Once the message and its proof (corresponding values of the HHT or MHT) are received, the destination calculates the root associated with the message by traversing the tree to retrieve hashes of siblings of nodes on a path between the leaf holding and a root of the hash tree. The destination compares the calculated root with the previously stored roots which had been received within the last timeAllowedtoLive duration as part of the pre-verification process at step 1110. If a match is found, the authenticity of the received message m′_{i,t} is authenticated and the received message is accepted as valid. Contrarily, if a match is not found, the message m′_{i,t} is rejected as an unauthenticated or invalid message.

At any point of time, the destination apparatus only has access to the root value and the proof value associated with specific messages received by the destination apparatus. The proof values (values from the data structure associated with the specific received message) are sufficient for the destination apparatus to calculate a root value and use the calculated root value for verifying the authenticity of the received message.

### CMMA (Pre-MMA) for Broadcast/Multicast ICS Communication Using TESLA Protocol (CMMA Embodiment

Using binary trees to combine the prioritization outcome into a single root value advantageously reduces the communication overhead and the computation overhead of the source apparatus. However, the factor of N still appears in the corresponding complexity expressions in Table 1, because the cryptographic evidence to prove the root integrity is generated separately for each destination. In a multicast setting, to avoid computing MACs separately for each destination, some embodiments introduce a source of asymmetry between the source and destinations. The asymmetry facilities the verification of prioritization outcomes by the destinations apparatuses. A CMMA embodiment incorporates an adaptation of TESLA protocol to introduce time asymmetry while relying on the reasonable assumption that the destinations are loosely time-synchronized with the source in a smart grid.

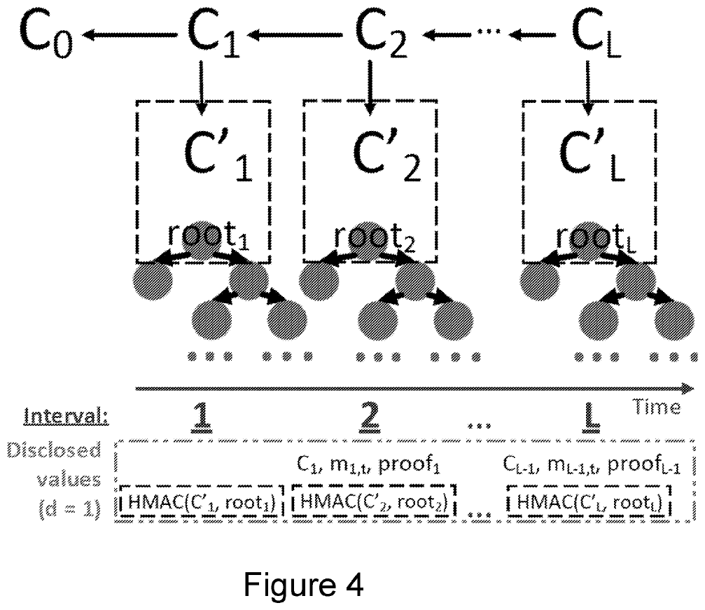

The TESLA protocol: According to the plain TESLA (Timed Efficient Stream Loss-tolerant Authentication) protocol, the source apparatus generates a hash chain by iteratively applying a one-way function H-constructed using a pseudorandom function family-starting from a random number C_{L}. That is, Cᵢ₋₁=H(Cᵢ), ∀i∈1, . . . , L hence producing the sequence of hash chain values, C₀, C₁, . . . , C_{L} in the reverse order of generation. Since H is a one-way function, no apparatus other than the source apparatus knows or has access to Cᵢ given Cᵢ₋₁. However, any apparatus possessing C₀ can readily verify if a given value belongs to the hash chain (and hence generated by the source) by checking if H′ (value)=C₀ for some i. Each hash chain value Cᵢ corresponds to a specific transmission interval as illustrated in FIG. 4.

After generating the hash chain, the source distributes C₀ to every destination securely, e.g., using digital signatures, or using the commitment of the previous hash chain (C_{L}) if any. To authenticate each message, the source computes and attaches the MAC to each transmitted message using the key chain in the reverse of generation: C₁, C₂, . . . , C_{L}. i.e., for the j′th message, Cj is used as the MAC or used to compute the MAC of the j′th message.

Along with the j′th message, the source reveals or transmits the key Ci, which was used to compute the MAC of the earlier i′th message. By obtaining Cᵢ, the destination(s) can verify the authenticity of the i′th message by checking Hⁱ(Cᵢ)=C₀, or simply H(Cᵢ))=Cᵢ₋₁ if the destination possesses Cᵢ₋₁. The transmission of the hash key chain values is delayed by (j−i) messaging intervals. The delay in transmission of the hash key chain values advantageously introduces source-destination(s) asymmetry without having to resort to computationally and administratively expensive public key cryptography.

According to the TESLA protocol, one MAC per message is sufficient to provide broadcast/multicast authentication, provided that the destinations have loose time synchronization with the source. However, the major drawback of TESLA (or delayed key disclosure schemes in general) is the delay in verification of each message introduced by the disclosure delay. Disclosure delay in the order of a few messaging intervals (i.e., larger than the sum of maximum network delay and synchronization error) is not tolerable in a time-critical setting.

In some embodiments, CMMA authenticates the prioritization outcomes (root values of the data structures for generating cryptographic evidence) using the TESLA protocol, as an alternative to authenticating the true message itself. FIG. 4 is a schematic diagram illustrating parts of a CMMA embodiment. A hash key chain C_{L}-> . . . . C₂->C₁->C₀ is generated by the source apparatus during the initialise operation described below. Each key of the hash key chain is used to authenticate the respective rootᵢ of the data structure for the generation of cryptographic evidence.

The embodiment authenticating the prioritization outcomes (root values) using TESLA advantageously does not suffer from the disclosure delay of TESLA, despite using it to introduce source/destination asymmetry.

Initialize (commitment of the previous hash chain)→{C₀, . . . , C_{L}, proof for C₀}: In embodiments that incorporate verification using the TESLA protocol, the initialise keys step 1010 of method 1000 also includes initialisation of a hash chain according to the TESLA protocol.

The hash key chain initialization procedure outputs a key chain of L+1 has chain values, and the proof for the first value by using the commitment of the previous hash chain, C_{L}′. The source apparatus selects a random number C_{L}, and commits it to generate a hash-chain of length L+1, by repeatedly applying a one-way function H (first hash function), such that Cᵢ₋₁=H(C), ∀i∈1, . . . , L. {C)} values are referred to as pre-computed data structure/root authentication keys or TESLA keys and they are used in the reverse order of generation, i.e., from Cᵢ to C_{L}, to authenticate the root values for the messages in the next L time intervals. Finally, the source generates a proof for the first TESLA key C₀ and the key disclosure schedule using the commitment of the previous hash chain (C_{L}′) if any, otherwise digitally signs C₀ and the key disclosure schedule before sending them to the destination(s).

Another hash function (second hash function) H′ is applied on C's to derive the actual keys used in MAC computation for transmission of the part of the data structure for cryptographic verification (for example for verification of root values). Thus, the CMMA embodiment follows the same rule and use another set of keys derived from the TESLA keys, Cᵢ′=H′(C), ∀i∈0, . . . , L, to compute the MAC for messages in the next L time intervals enabling the destination apparatus to verify the received root values using the respective keychain values (Cᵢ) for each interval.

Predict operates in substantially the same way as for CMA for Unicast ICS Communication.

Tree Construction (Mᵢ, Pᵢ, Cᵢ, tsᵢ)−→{treeᵢ, rootᵢ, sᵢ}: As part of the step 1030 of determination of the data structure 917 for generation of cryptographic evidence, the CMMA embodiments perform the tree construction with key chain value Cᵢ as one of the inputs. The inputs to the tree construction procedure are Mᵢ, Pᵢ obtained from the output of the Prioritize/predict procedure, the TESLA key Cᵢ for time interval i, and the timestamp tsᵢ. The outputs are the tree treeᵢ, its root value rootᵢ, and the MAC sᵢ for rootᵢ, computed using Cᵢ.

In the tree construction procedure for the CMMA embodiment, the source apparatus constructs an HHT on the set of prioritized messages. Since an adversary may predict such messages, each leaf node is nonced with a random value in {r_{i,1}, . . . , r_{i,2k}}. The source apparatus then computes a MAC for the tree's root, rootᵢ, using the hash of the corresponding TESLA key Cᵢ, such that sᵢ=HMAC(H′(Cᵢ),tsᵢ,rootᵢ). sᵢ (also referred to as cryptographic proof) is shared with the destination(s) at step 1040 and serves as the public meta-data within the ICS network. The tree is only known to the source, thus serves as the private meta-data. Only a single public meta-data value sᵢ is computed for all destinations.

The data structure for generation of cryptographic evidence/proof and the root values generated based on the data structure are recalculated/updated by the source apparatus of the CMMA embodiment for each transmission interval as illustrated in FIG. 4. With respect to the flowchart 1000 of FIG. 10, the step of computation of the data structure 1030 may be executed for each interval as identified in FIG. 4. Within each interval, multiple true messages may be transmitted and their respective cryptographic proof be calculated using the updated data structure. As an interval comes to an end, the step 1030 is re-executed for the next interval to generate an updated data structure for generation of cryptographic proof/evidence. Based on the recalculated/updated data structure and the hash chain value corresponding to the specific transmission interval, the cryptographic proof (proofᵢ=HMAC(H′(Cᵢ),tsᵢ,rootᵢ)) value is calculated by the source apparatus for each true message.

Prove (m_{i,t}, treeᵢ)→{proofᵢ}: The inputs are the true message m_{i,t}∈Mᵢ and the treeᵢ constructed in the previous procedure, and the output proof is a collection of values from the tree. After the true message m_{i,t} is known to the source apparatus (say d time intervals after the tree construction step), it sends m_{i,t} and the corresponding values of treeᵢ that will allow the destination(s) to calculate rootᵢ. The source also transmits the root encryption key (TESLA key) Cᵢ together with the message at step 1060 to allow the destination(s) to verify root (transmitted as part of the prioritization outcome HMAC(H′(Cᵢ),tsᵢ,rootᵢ)value). Note that the root encryption key Cᵢ used to verify the rootᵢ is transmitted to the destination apparatus at a delayed time (d+i with respect to the time of transmission of the prioritization outcome at 1040) to create time asymmetry between the source and destination(s), but this disclosure delay is not reflected in the authentication of m_{i,t}, as long as the prioritization outcome (sᵢ=HMAC(H′(Cᵢ), tsᵢ, rootᵢ) value) precedes the true message by more than the minimum disclosure delay allowable by the system.

As illustrated in FIG. 4, in interval 1, s₁=HMAC(H′(C₁),tsᵢ,rootᵢ) is transmitted by the source apparatus. In interval 2, C₁, mᵢ,proofᵢ and $2 is transmitted by the source. C₁ is used by the destination apparatus to verify sᵢ received earlier by the destination apparatus. This delayed verification of s₁ creates time asymmetry between the source and the destination. After verification of s₁, the destination apparatus may verify the proof₁ associated with the message m₁ to verify the authenticity of the message m₁.

Pre-Verify: CMMA embodiments need not perform the pre-verification steps 1110, 1120. The verification step performed by the CMMA embodiments comprises a unified verification step described below.

Verify (Cᵢ,Cᵢ₋₁,sᵢ,m_{i,t}, proofᵢ)→{accept, rejecti}: The CMMA embodiments perform a verification step (step 1140) that takes into account the hash key chain values Cᵢ, Cᵢ₋₁. The inputs to the verify procedure are TESLA keys Cᵢ, Cᵢ₋₁, the MAC sᵢ of rootᵢ, the true message m_{i,t} and the proof proofᵢ for the true message. Instead of receiving the root separately, the destination apparatus of the CMMA embodiment receives the MAC value sᵢ generated based on the rootᵢ value determined by the source apparatus.

As part of the verify procedure, first, the destination apparatus verifies the TESLA key Cᵢ using a previously disclosed key, e.g., H(C)=Cᵢ₋₁. If Cᵢ₋₁ was not received due to packet loss etc., the destination can still verify Cᵢ by repeatedly applying the hash function H on Cᵢ to obtain the last received TESLA key, i.e., H^{J}(Cᵢ)=Cᵢ₋ⱼ.

If verified, Cᵢ is used to verify the true message, and also stored to verify the future values of the hash chain to be received. Then, using the proofᵢ, the destination traverses the tree to retrieve hashes of siblings of nodes on a path starting from the leaf holding mit, hence calculating the root value rootᵢ. Finally, the destination apparatus verifies if the received value sᵢ=HMAC(H′(Cᵢ),tsᵢ,rootᵢ). If verified, the true message m_{i,t} is authenticated.

### Performance and Security Analysis

Table 1 reproduced earlier includes the complexity of CMA and CMMA schemes according to the embodiments. In both schemes, the source does not perform any computations other than memory reads and packet assembly in the post-message phase (the phase after which the true message is available to the source apparatus). The source retrieves the values corresponding to the true message from the tree and incorporates them into a proof generated for the true message.

For the pre-message phase, given k possible binary fields and hence 2k possible messages in a prioritization outcome, the binary tree allowing the generation of the root values and proof can be constructed with 2^{k+1}−1 hash operations (i.e., 2k to generate the leaves, plus 2^{k}−1 to construct the rest of tree). Given prioritization outcomes at a rate of R₂, the required computing rate at the source to generate the binary tree would be (2^{k+1}−1)R₂ number of secure hash operations per unit time. The tree generation complexity is common for both CMA and CMMA. Added to this is the generation of MACs, which requires 2NR₂ secure hashing operations (two per destination, per tree) for CMA and 4R₂ secure hashing operations (two for the MAC of root values, one for deriving the TESLA key and one for the key of MAC from the TESLA key) for CMMA per unit time. So the total computing load at the source would be (2N+2^{k+1}−1)R₂ for CMA and (3+2^{k+1})×R₂ for CMMA.

In CMA embodiments, the destination verifies the root before the true message is received (Pre-Verify procedure), and the proof after (Verify procedure) the true message is received. The root verification in the Pre-Verify procedure uses MACs, and demands a computing rate of 2R₁ secure hashing both for MHT and HHT variants. For a MHT, proof verification in the Verify procedure costs (k+1)R₁ secure hashing operations. The verification complexity of the HHT proof depends on where the received message is located on the tree. The required computing load is 2R₁ for the message at depth 1, and (D+1)R₁ in general, where D is the depth of the actual message in the HHT, and D≤2^{k}−1. So, the total computing load at the destination is between 4R₁ and (2+2^{k})R₁ for HHT and (k+3)R₁ for MHT embodiments.

The communication overhead for distributing MACs to N destinations is NR₁ for both MHT and HHT. The proof size is (k+1)R₁ for MHT, and (D+1)R₁ for HHT which corresponds to 2R₁ for the most likely message, while the average is smaller than that of MHT. The total communication overheads are also shown in Table 1. The average communication and verification overheads are both smaller with HHT.

In CMMA in addition to the computations above, the corresponding TESLA key is verified by the destination apparatus using the previously disclosed TESLA key, and the key of the MAC is generated from it, each costing a secure hashing. Therefore the computing load is 2R₁ more than the CMA embodiments.

The proof size is (k+1) hash values for MHT, and (D+1) for HHT, which yields 2 for the most likely (or delay stringent) message in CMA. Adding the MAC to the proof contributes one more hash value to the communication overhead. In CMA the proof is communicated separately to N destinations, hence bringing the total communication overhead to N (k+2) and N (D+2) for MHT and HHT variants. In CMMA the same proof and MAC, as well as the corresponding TESLA key, is shared with all destinations, totalling N (k+3) and N (D+3) hash values for its MHT and HHT variants.

In C(M)MA a nonce is released when the message corresponding to that nonce is sent. Therefore, a nonce is refreshed once that happens. For 128-bit security, some embodiments incorporate 256 bit nonces and a secure hash function, such as SHA-256. Using 128-bit nonces and a secure hash function with 128-bit security, such as e.g., SHA-256, provides a greater degree of defence against a brute force attack.

### Implementation and Evaluation

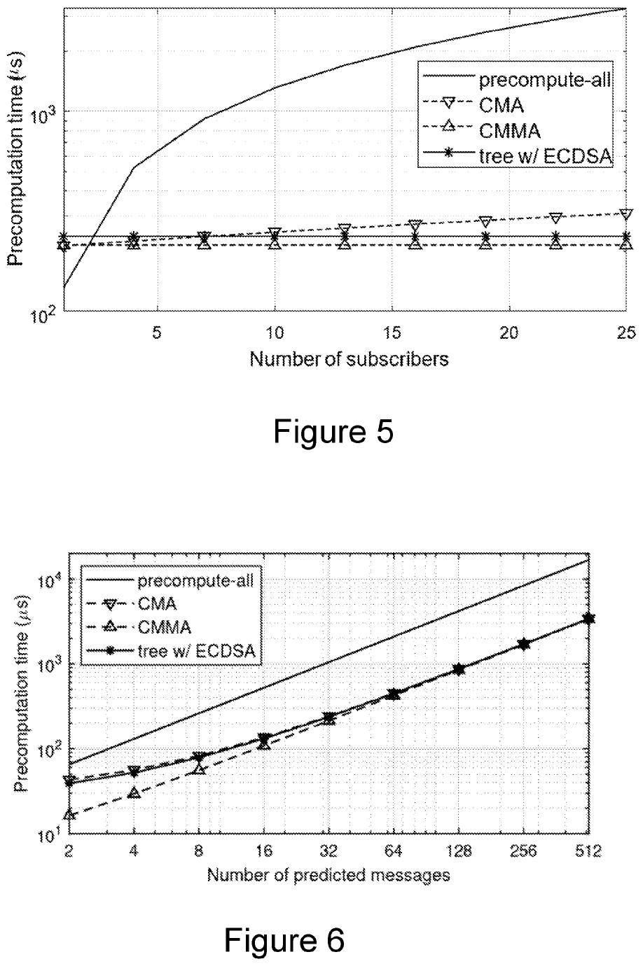

During the evaluation, the average time taken for subtasks of the baseline designs, CMA and CMMA, as well as the widely used ECDSA were measured. The ECDSA plots of FIGS. 5 and 6 are based on the same authenticated tree-based approach to bind prioritization outcomes into a single root value, but ECDSA was used to authenticate the root. Consequently, the PreVerify step of “tree with ECDSA” involves the verification of ECDSA signature. Since the post-message signing consists only of memory reads and packet assembly (as per the described Prove procedures of CMA and CMMA), it is performed virtually instantly, and hence not evaluated.

### Precomputation Time

The precomputation time does not contribute to the delay overhead as long as it is shorter than a messaging interval, yet it determines the maximum messaging throughput. FIG. 5 compares the precomputation time of CMA and CMMA based techniques with “tree with ECDSA” and the baseline approach of precompute all, over the number of destinations, assuming 32 prioritized messages are available for a potential transmission. As can be seen in the graph of FIG. 5, the precomputation time increases with the number of destinations for precompute-all, and CMA schemes. This is because the source needs to precompute a separate proof for each destination, using the corresponding pairwise symmetric keys. Nevertheless, the amount of increase for CMA is much smaller due to the use of authenticated trees rather than generating a separate proof for each prioritization outcome. The precomputation times for CMMA and ECDSA do not depend on the number of destinations due to the time asymmetry for the former, and key asymmetry for the latter. CMMA outperforms ECDSA thanks to the use of symmetric keys.

In FIG. 6, precomputation time is plotted as a function of the number of predicted/prioritized messages. All schemes suffer increased precomputation time due to multiple MAC computations in precompute-all and due to larger tree size in tree-based schemes (i.e., CMA, CMMA, and tree with ECDSA). At 32 messages, the precomputation times for CMMA and CMA were 210-250 μs. If the true message is always in the set of prioritized messages, C(M)MA embodiments therefore potentially support the throughput of 4000 messages per second in IEC 61850 SV. CMMA's precomputation time is the shortest, outperforming tree'd ECDSA with approximately 23 us margin regardless of the number of subscribers or messages in FIGS. 5 and 6. Although the 23 us difference is not substantially large.

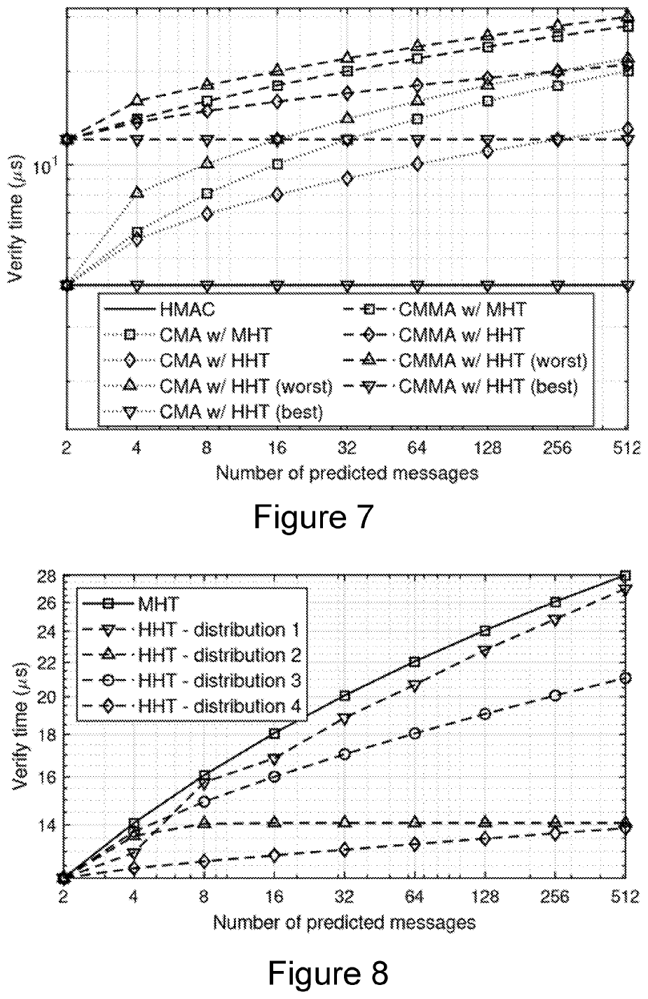

FIG. 7 illustrates the verification time of CMMA and CMA with the HMAC as a benchmark, since MACs (in straw man and precompute-all design) have the smallest verification time (4 μs). HHT based CMMA and CMA constructions have lower average verification times than those with MHT because the average depth of the actual message is minimized in HHT (assuming message likelihood based HHT). The best case for HHT based construction would be when the most likely message is the true message. In the plain TESLA protocol, the disclosure delay is added to the verification time, therefore, it would incur significantly larger verification delay than C(M)MA. As a rough comparison, even under ideal circumstances, TESLA would incur 250 us compared to several us of C(M)MA.

FIG. 8, illustrates how the probability distribution of future messages affects the verification time of C(M)MA with HHT. Only CMMA is shown on this figure for brevity (CMA would be 6-8 us faster than CMMA). Given that there are 2k possible messages, the four probability distributions we consider are:
Distribution 1: Samples of 2^{k} i.i.d exponential random variables were drawn their sum was normalized to 1
Distribution 2: Pr(mᵢ)=2⁻ⁱ, for i≤2^{k}−1, Pr(m₂ₖ)=2⁻²^{^{K}}⁺¹
Distribution 3: Pr(m₁)=0.5, Pr(mᵢ)=0.5/(2^{k}−1) for i≥2
Distribution 4: Pr(m₁)=0.9, Pr(mᵢ)=0.1/(2^{k}−1) for i≥2

As illustrates in FIG. 8, CMMA with HHT performs significantly better than CMMA with MHT, when certain messages have a markedly higher probability than others (distributions 2 and 4). In particular, distribution 4 yields the best results, because message 1, with a much lower depth in the HHT, is the message to be authenticated in 9 out of every 10 messaging intervals.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An apparatus for providing authentication information, the apparatus comprising:
one or more processors;
a memory storing instructions that when executed by the one or more processors, cause the apparatus to:
generate a plurality of predicted messages based on a known structure of a message and/or based on a plurality of past messages having a same structure as the message;
pre-compute, based on at least one of the predicted messages, a data structure for generation of cryptographic evidence for future messages;
receive a true message;
determine a cryptographic proof for the true message based on the pre-computed data structure; and
transmit the true message and the cryptographic proof to at least one message destination apparatus.

2. The apparatus according to claim 1, wherein the pre-computed data structure is determined based on at least a most likely or urgent one of the predicted messages.

3. The apparatus according to claim 1, wherein execution of the instructions by the one or more processors further causes the apparatus to determine the cryptographic proof by:
comparing content of the true message to the predicted messages;
selecting one of said predicted messages based on its similarity or identity to the true message; and
retrieving the cryptographic proof from the pre-computed data structure using the selected one of the predicted messages.

4. The apparatus according to claim 1, wherein determining the pre-computed data structure comprises constructing an authenticated binary tree based on the predicted messages.

5. The apparatus according to claim 4, wherein the authenticated binary tree is constructed based on: the predicted messages and probabilities of the respective predicted messages.

6. The apparatus according to claim 4, wherein each leaf node of the binary tree contains a hash of a concatenation of one of the plurality of predicted messages and a nonce value.

7. The apparatus according to claim 6, wherein execution of the instructions by the one or more processors further causes the apparatus to:
determine a root value for the authenticated binary tree by iterative pairwise hashing of values of nodes of the binary tree; and
share the root value with the at least one message destination.

8. The apparatus according to claim 6, wherein execution of the instructions by the one or more processors further causes the apparatus to determine the cryptographic proof by:
determining a leaf node in the binary tree that corresponds to the true message; and
traversing the binary tree to retrieve hashes of siblings of nodes on a path between the corresponding leaf node and a root;
wherein the cryptographic proof comprises a combination of the nonce value of the corresponding leaf node, and the hashes of all sibling nodes on the path.

9. The apparatus according to claim 7, wherein execution of the instructions by the one or more processors further causes the apparatus to:
share the root value with a plurality of message destinations, each respective message destination being associated with a different respective symmetric key.

10. The apparatus of according to claim 1, wherein execution of the instructions by the one or more processors further causes the apparatus to:
initialise a series of hash chain values, the series of hash chain values comprising a final hash chain value (C₀), wherein each hash chain value (Cᵢ) corresponds to a specific transmission interval (i); and
transmit the final hash chain value (C₀) to at least one message destination apparatus.

11. The apparatus of claim 10, wherein the apparatus transmits a hash chain value corresponding to a current interval in addition to the true message and the cryptographic proof to the at least one message destination apparatus.

12. The apparatus of claim 11, wherein execution of the instructions by the one or more processors further causes the apparatus to:
recalculate the data structure for generation of cryptographic evidence for each specific transmission interval;
the cryptographic proof is determined based on the recalculated data structure and the hash chain value corresponding to the specific transmission interval.

13. An apparatus for receiving information and authenticating received information, the apparatus comprising:
one or more processors; and
a memory storing instructions that when executed by the one or more processors, cause the apparatus to:
receive a first root value for authenticating future messages;
verify the received root value using a known symmetric key;
receive a message and a cryptographic proof generated by the apparatus of claim 1; and
verify the received message by calculating a second root value based on the cryptographic proof and comparing the second root value with the first root value.

14. An apparatus for receiving information and authenticating received information, the apparatus comprising:
one or more processors; and
a memory storing instructions that when executed by the one or more processors, cause the apparatus to:
receive a final hash chain value from a message source apparatus;
verify the received final hash chain value using a digital signature or a previously received hash chain value;
receive a message, a cryptographic proof and a hash chain value from the apparatus of claim 11;
verify the current hash chain value based on the previously received final hash chain value; and
verify the received message based on the cryptographic proof and the verified current hash chain value.

15. A method for providing authentication information for a message, comprising, at a message source:
prior to receiving or generating the message:
generating a plurality of predicted messages based on a known structure of the message and/or based on a plurality of past messages having a same structure as the message; and
pre-computing, based on at least one of the predicted messages, a data structure for generation of cryptographic evidence for future messages; and
on receiving or generating the message (true message), determining a cryptographic proof for the true message based on the pre-computed data structure.

16. The method according to claim 15, wherein the pre-computed data structure is determined based on at least a most likely or urgent one of the predicted messages.

17. The method according to claim 15, wherein the plurality of predicted messages is all possible prospective messages, and wherein the pre-computed data structure is determined based on the plurality of predicted messages.

18. The method according to claim 15, wherein the cryptographic proof is determined by:
comparing content of the true message to the predicted messages;
selecting one of said predicted messages based on its similarity or identity to the true message; and
retrieving the cryptographic proof from the pre-computed data structure using the selected one of the predicted messages.

19. The method according to claim 15, wherein determining the pre-computed data structure comprises constructing an authenticated binary tree on the predicted messages.

20. The method according to claim 19, wherein the authenticated binary tree is constructed based on:
the predicted messages; and
probabilities of the respective predicted messages.

21. The method according to claim 19, wherein each leaf node of the binary tree contains a hash of a concatenation of one of the plurality of predicted messages and a nonce value.

22. The method according to claim 21, comprising:
determining a root value for the authenticated binary tree by iterative pairwise hashing of values of nodes of the binary tree; and
sharing the root value with at least one message destination using a symmetric key.

23. The method according to claim 21, wherein the cryptographic proof is determined by:
determining a leaf node in the binary tree that corresponds to the true message; and
traversing the binary tree to retrieve hashes of siblings of nodes on a path between the corresponding leaf node and a root;
wherein the cryptographic proof comprises a combination of the nonce value of the corresponding leaf node, and the hashes of all sibling nodes on the path.

24. The method according to claim 22, wherein the root value is shared with a plurality of message destinations.

25. The method according to claim 22, wherein the root value is authenticated according to TESLA protocol.

26. A method for authenticating a message from a message source, comprising:
an initialisation operation comprising receiving a symmetric key from the message source;
a pre-verification operation conducted before receiving messages from the message source and comprising:
receiving a root value and an HMAC (hash-based message authentication code) from the message source, wherein the root value is a root value of an authenticated binary tree, each leaf node of the binary tree containing a hash of a concatenation of a predicted message and a nonce value; and wherein the HMAC is generated by the message source the root value, and a timestamp;
verifying the root value using the HMAC;
if the root value is verified, storing the root value; and
an authentication operation comprising:
receiving, from the message source, the message and a cryptographic proof of the message, wherein the cryptographic proof comprises a combination of a nonce value of a leaf node corresponding to the message, and the hashes of all sibling nodes on a path between the leaf node and the root of the binary tree; and
verifying the message by traversing the binary tree, using the cryptographic proof, to compute a verification value; and comparing the verification value to the stored root value.

27. The method according to claim 26, wherein the root value is verified according to TESLA protocol.

28. An apparatus for authenticating a message from a message source, comprising:
memory; and
at least one processor in communication with the memory;
wherein the memory comprises machine-readable instructions for causing the at least one processor to carry out the method according to claim 26.

29. A non-transitory computer-readable storage medium having stored thereon machine-readable instructions for causing at least one processor to carry out the method according to claim 15.
